(19) United States
(12) Patent Application Publication
(10) Pub. No.: US 2008/0002519 A1
(43) Pub. Date: Jan. 3, 2008

(54) MIXING HEAD, AND METHOD OF OPERATING SUCH A MIXING HEAD

(75) Inventors: WOLFGANG SOECHTIG, Germering (DE); Josef Renkl, Markt Indersdorf (DE); Ernst Berchtenbreiter, Kissing (DE)

Correspondence Address: Henry M. Feiereisen;Henry M. Feiereisen, LLC, Suite 4714, 350 Fifth Avenue, New York, NY, 10118, US

(73) Assignee: Krauss Maffei GmbH, Munchen (DE)

(21) Appl. No.: 11/839,848

(22) Filed: Aug. 16, 2007

Related U.S. Application Data
(63) Continuation of application No. PCT/EP06/50181, filed on Jan. 12, 2006.

(30) Foreign Application Priority Data
Feb. 22, 2005 (DE) 10 2005 007 979.2

(51) Int. Cl. B01F 15/02

(52) U.S. Cl. 366/159.1

(57) ABSTRACT

A mixing head for mixing at least two reactive starting materials includes a feed passageway for introduction of a high-viscosity starting material, and a return passageway for the high-viscosity starting material for allowing circulation of the high-viscosity starting material. The high-viscosity starting material can be introduced into a mixing chamber for subsequent mixing with a via at least one injection port. A switchover device is provided for selectively establishing a flow communication between the feed passageway and the mixing chamber and a flow communication between the feed passageway and the return passageway, wherein the flow communication between the feed passageway and the mixing chamber is provided upstream of the at least one injection port.

### CROSS-REFERENCES TO RELATED APPLICATIONS

This application is a continuation of prior filed copending PCT International application No. PCT/EP2006/050181, filed Jan. 12, 2006, which designated the United States and has been published but not in English as International Publication No. WO 2006/089816 and on which priority is claimed under 35 U.S.C. §120, and which claims the priority of German Patent Application, Serial No. 10 2005 007 979.2, filed Feb. 22, 2005, pursuant to 35 U.S.C. 119(a)-(d), the contents of which are incorporated herein by reference in its entirety as if fully set forth herein.

### BACKGROUND OF THE INVENTION

The present invention relates to a mixing head for mixing at least two chemically reactive starting materials, and to a method of operating such a mixing head.

Nothing in the following discussion of the state of the art is to be construed as an admission of prior art.

A mixing head for a high-pressure counterflow injection process has a mixing chamber in which two jets of material components, e.g. polyurethane components, are injected at high pressure toward one another and mixed as they impact each other. Both material components are hereby conducted through a nozzle. This process is unsuitable for mixing high-viscosity materials, in particular those admixed with filler material, e.g. fibers, because the fibers cause clogging of the nozzles.

In reaction injection molding process (RIM process), reinforcing fibers are oftentimes used in order to improve mechanical properties of finished products. The strength of the product is hereby dependent on the fiber length. While fiber lengths of up to 0.5 mm in the starting material cause normally little problem, this is not the case, when the fiber length reaches 1.0 mm or even 3.0 mm. In particular, when the starting material contains fibers of a length of more than 3.0 mm, the RIM process proved unsuitable heretofore. The incorporation of long fibers, such as glass fibers or natural fiber for example, is however more and more in demand in order to enhance physical properties and material quality that improve with increase in the fiber length.

U.S. Pat. No. 5,858,416, issued Jan. 12, 1999, discloses a mixing head for combining chemically reactive plastic components to a mixture of synthetic resin. Long fibers are admixed outside the mixing chamber to the mixture, e.g. via a tube. In this type of long fiber injection (LFI-process), the mixture can be transferred to an open injection mold only, using a robot arm by which the mixing head is displaced over a surface of the open injection mold. The mold is then closed and the product is formed as the reactive components cure. This process is inefficient and costly.

It would be desirable and advantageous to provide an improved mixing head to obviate prior art shortcomings.

### SUMMARY OF THE INVENTION

According to one aspect of the present invention, a mixing head for mixing at least two reactive starting materials includes a feed passageway for introduction of a high-viscosity starting material, a return passageway for the high-viscosity starting material, a mixing chamber receiving the high-viscosity starting material, at least one injection port for introduction of a low-viscosity starting material into the mixing chamber for mixing the high-viscosity and low-viscosity starting materials with one another; and a switchover device for selectively establishing a flow communication between the feed passageway and the mixing chamber and a flow communication between the feed passageway and the return passageway, wherein the flow communication between the feed passageway and the mixing chamber is provided upstream of the at least one injection port.

According to another aspect of the present invention, a method of operating a mixing head constructed for mixing two starting materials, includes the steps of connecting a feed passageway with a return passageway for circulation of a first starting material which contains fibers, cutting a flow communication between the feed passageway and the return passageway, thereby opening a flow communication between the feed passageway and a mixing chamber for introduction of the first starting material into the mixing chamber, injecting a second starting material of lower viscosity than the first starting material into the mixing chamber at a location downstream of the introduction of the first starting material into the mixing chamber, thereby mixing the first and second starting materials to produce a reactive mixture, and discharging the reactive mixture from the mixing chamber.

Suitably, the high-viscosity starting material is introduced into the mixing chamber at relatively low pressure, or circulates between the feed passageway and the return passageway at low pressure. In contrast thereto, the low-viscosity starting material can be injected into the mixing chamber at high pressure.

According to another feature of the present invention, the feed passageway, the return passageway, and the flow communication between the feed passageway and the return passageway may be constructed in the absence of any substantial cross-sectional narrowing. In other words, the presence of any significant restricted flow zones should be avoided because of the potential of a pressure buildup and material deposit as a result of a reduced flow cross section. Thus, clogging is effectively prevented, especially of nozzles, and introduction of a reactive component as starting material, which can contain fibers of any length, especially those above 3.0 mm, can be easily processed also in a closed mold. Suitably, the feed passageway, the return passageway, and the flow communication between the feed passageway and the return passageway have a same cross section, and the flow communication between the feed passageway and the mixing chamber has a substantial same flow cross section as the feed passageway.

According to another feature of the present invention, the switchover device may include a cleaning piston disposed in the mixing chamber for back-and-forth movement, with the cleaning piston being constructed to establish a flow communication between the feed passageway and the return passageway in one position, and a flow communication between the feed passageway and the mixing chamber in another position. Suitably, the cleaning piston assumes a retracted disposition in its other position, when the feed passageway and the mixing chamber are fluidly connected.

According to another feature of the present invention, the cleaning piston has one end which may be constructed to deflect the high-viscosity starting material from the feed passageway into the mixing chamber.

According to another feature of the present invention, the flow communication between the feed passageway and the return passageway in the one position of the cleaning piston may be realized by a bore or annular groove in the cleaning piston.

According to another feature of the present invention, the mixing head may have a plurality of injection ports for introduction of the second starting material into the mixing chamber. Suitably, the injection ports are disposed in ring-shaped spaced apart surrounding relationship about the mixing chamber. The injection ports may hereby operatively connected to a plurality of injection nozzles in one-to-one correspondence, with the injection nozzles operated independently from one another, e.g. hydraulically. In this way, injection of the second starting material into the mixing chamber can be realized at especially high pressure, e.g. 100-300 bar, thereby ensuring an intimate mixture with the first starting material.

A mixing head according to the present invention is easy to construct and reliable in operation to allow introduction of a reactive material also into a closed injection mold, when high-viscosity starting materials are used, in particular those containing fibers of which at least some have a length of more than 3.0 mm. Even fiber lengths of up to 25 mm and more can be reliably processed. As high-viscosity starting material is introduced into the mixing chamber at relatively low pressure, e.g. up to 40 bar, and in the absence of any significant cross-sectional narrowing, the high-viscosity starting material may contain long-fiber fillers, without encountering any malfunction due to clogging.

### BRIEF DESCRIPTION OF THE DRAWING

Other features and advantages of the present invention will be more readily apparent upon reading the following description of currently preferred exemplified embodiments of the invention with reference to the accompanying drawing, in which:

FIG. 1 is a schematic sectional view of an embodiment of a mixing head according to the present invention, illustrating a cleaning piston in a forward position;

FIG. 2 is a schematic sectional view of the mixing head of FIG. 1, illustrating the cleaning piston in a retracted position; and

FIG. 3 is a schematic sectional view of the mixing head of FIG. 1, taken along a different section plane to show injection nozzles.

### DETAILED DESCRIPTION OF PREFERRED EMBODIMENTS

Throughout all the Figures, same or corresponding elements may generally be indicated by same reference numerals. These depicted embodiments are to be understood as illustrative of the invention and not as limiting in any way. It should also be understood that the figures are not necessarily to scale and that the embodiments are sometimes illustrated by graphic symbols, phantom lines, diagrammatic representations and fragmentary views. In certain instances, details which are not necessary for an understanding of the present invention or which render other details difficult to perceive may have been omitted.

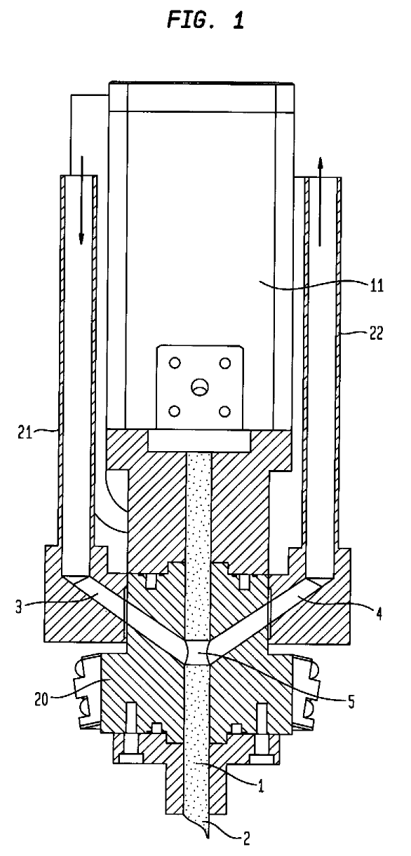

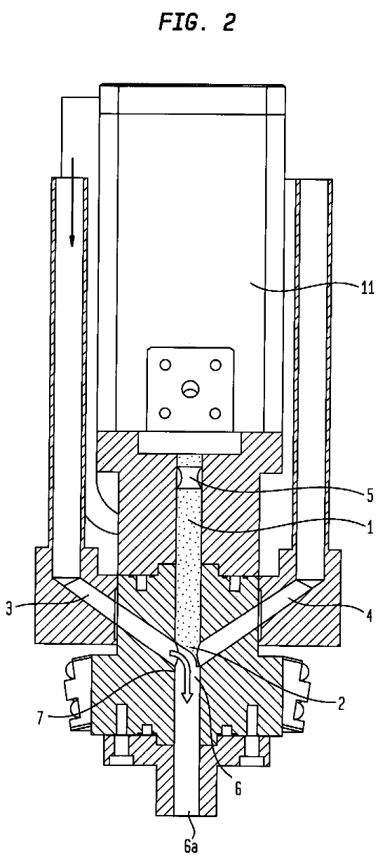

Turning now to the drawing, and in particular to FIG. 1, there is shown a schematic sectional view of an embodiment of a mixing head according to the present invention, including a multipart housing 20 which has a cylindrical mixing chamber 6. At a lower end thereof, the mixing chamber 6 has an outlet 6a (FIG. 2) through which a mixture of chemically reactive components that have been mixed in the mixing chamber 6 exit the mixing head and are introduced, e.g., into a closed injection mold. One chemically reactive component involves a high-viscosity starting material, e.g. polyol material containing fibers, and is supplied to the mixing head via a feed duct 21 which is fluidly connected to the mixing chamber 6 via a feed passageway 3 provided in the mixing head. The mixing head is further connected to a return duct 22 which is fluidly connected to the feed passageway 3 via a return passageway 4 provided in the mixing head. Both, the feed passageway 3 and the return passageway 4, end in the mixing chamber 6, as viewed in axial direction, at a same level.

Received in the mixing chamber 6 is a pin-shaped cleaning piston 1 which is sized to substantially fill the interior of the mixing chamber 6 while still being capable to move up and down. FIG. 1 shows the cleaning piston 1 in a forward position, whereas FIG. 2 shows the cleaning piston 1 in a retracted position. Operation of the cleaning piston 1 to move between the forward and retracted positions is implemented by a hydraulic cylinder 11.

The cleaning piston 1 includes a bore 5 arranged in the cleaning piston 1 to establish a flow communication between the feed passageway 3 and the return passageway 4, when the cleaning piston 1 assumes the forward position. As a result, the high-viscosity starting material can circulate between a reservoir (not shown) via the feed duct 21, feed passageway 3, bore 5, return passageway 4 and return duct 22 and back to the reservoir.

As shown in FIG. 1, the feed passageway 3, bore 5, and return passageway 4 have substantially identical flow cross sections so that a pressure buildup is low and no backup can be caused that could lead to clogging and resultant malfunction.

In the retracted position shown in FIG. 2, the bore 5 of the cleaning piston 1 has shifted upwards, thereby cutting the communication between the feed passageway 3 and the return passageway 4. The cleaning piston 1 is hereby retracted far enough so that a flow communication between the feed passageway 3 and the mixing chamber 6 can be established. As shown in FIGS. 1 and 2, the cleaning piston 1 has an end which is configured in the form of a nose 2 by which the high-viscosity starting material approaching from the feed passageway 3 is deflected into the mixing chamber 6. The nose 2 serves also as barrier against the return passageway 4 to thereby prevent high-viscosity starting material from migrating into the return passageway 4. As the flow cross sections of feed passageway 3 and transition thereof into the mixing chamber 6 as well as the mixing chamber 6 are substantially of same size, the high-viscosity starting material can be introduced into the mixing chamber 6 without any interference that may mar operation and at relatively low pressure, e.g. up to about 40 bar.

Another component of the chemically reactive mixture involves a starting material of lower viscosity which is injected into the mixing chamber 6 via injection ports 7 which are positioned downstream of the transition of feed passageway 3 to mixing chamber 6. A total of six injection ports 7 may be provided, of which however only three are shown in FIG. 2. The injection ports 7 are hereby positioned, by way of example, in spaced-apart circular surrounding relationship about the mixing chamber 6.

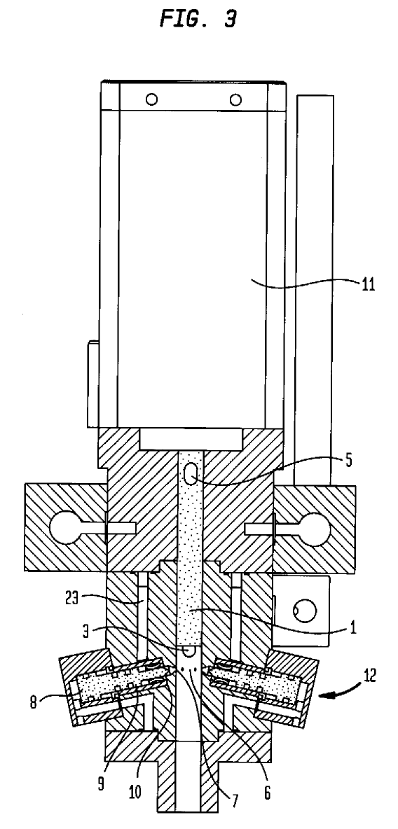

As can be seen from FIG. 3, which is a schematic sectional view of the mixing head of FIG. 1, taken along a different section plane, each of the injection ports 7 is associated to its own injection nozzle, generally designated by reference numeral 12. Each injection nozzle 12 is accommodated in the housing 20 and includes a nozzle pin 9 and a nozzle cone (seat) 10 which cooperate in such a way that the nozzle pin 9 clears or closes the nozzle cone 10. The nozzle pin 9 is hereby moved forwards and backwards in relation to the nozzle cone 10 by a control piston 8 which is operated hydraulically. Low-viscosity starting material is fed to the injection nozzles 12 via associated supply passages 23. Depending on the position of the control piston 8, a connection between the supply passage 23 and the mixing chamber 6 is thus controlled, i.e. cleared and closed, via the injection nozzle 12 and the injection port 7.

The low-viscosity starting material, introduced through the injection ports 7 into the mixing chamber 6 is constantly under high pressure of e.g. 100 to 300 bar, so as to realize a thorough and intimate mixture with the high-viscosity starting material in the mixing chamber 6.

The mode of operation of the mixing head is as follows: The cleaning piston 1 assumes, prior to injection of the chemically reactive components and implementation of the mixing process, the forward position shown in FIG. 1 so that the high-viscosity starting material circulates via bore 5. The injection nozzles 12 are closed so that low-viscosity starting material is prevented from migrating into the mixing chamber 6 via the injection ports 7. Ingress of low-viscosity starting material into the mixing chamber 6 is also prevented by the forward disposition of the cleaning piston 1. Although not shown in detail, the low-viscosity starting material may also circulate, when prevented from entry into the mixing chamber 6.

When commencing the injection and mixing processes, the cleaning piston 1 is retracted to assume the rearward disposition shown in FIG. 2. As a result, the flow communication between the feed passageway 3 and the return passageway 4 is cut. As soon as the cleaning piston 1 clears the flow communication between the feed passageway 3 and the mixing chamber 6, high-viscosity starting material is able to flow into the mixing chamber 6. At the same time or after retraction of the cleaning piston 1, the nozzle pins 9 are moved away from the nozzle cones 10 to open the injection nozzles 12. As a result, low-viscosity starting material can now flow into the mixing chamber 6 in which high-viscosity starting material is present. The injection nozzles 12 are suitably controlled in such a way that the injection of low-viscosity starting material is timed to coincide with an entry of high-viscosity starting material into the mixing chamber 6. The transport of high-viscosity starting material into the mixing chamber 6 and simultaneous injection of low-viscosity starting material is carried out long enough to ensure introduction of a sufficient amount of reactive components in foamed state through the outlet 6a into an injection mold, in particular a closed injection mold.

Thereafter, the cleaning piston 1 is moved forward again to assume the forward disposition, as shown in FIG. 1 so that the connection between the feed passageway 3 and the mixing chamber 6 is cut, and the mixing chamber 6 is cleaned while high-viscosity starting material is able to again circulate via the bore 5.

While the invention has been illustrated and described in connection with currently preferred embodiments shown and described in detail, it is not intended to be limited to the details shown since various modifications and structural changes may be made without departing in any way from the spirit of the present invention. The embodiments were chosen and described in order to best explain the principles of the invention and practical application to thereby enable a person skilled in the art to best utilize the invention and various embodiments with various modifications as are suited to the particular use contemplated.

What is claimed as new and desired to be protected by Letters Patent is set forth in the appended claims and includes equivalents of the elements recited therein:

What is claimed is:

1. A mixing head for mixing at least two reactive starting materials, comprising:
a feed passageway for introduction of a high-viscosity starting material;
a return passageway for the high-viscosity starting material;
a mixing chamber receiving the high-viscosity starting material;
at least one injection port for introduction of a low-viscosity starting material into the mixing chamber for mixing the high-viscosity and low-viscosity starting materials with one another; and
a switchover device for selectively establishing a flow communication between the feed passageway and the mixing chamber and a flow communication between the feed passageway and the return passageway,
wherein the flow communication between the feed passageway and the mixing chamber is provided upstream of the at least one injection port.

2. The mixing head of claim 1, constructed for use in a reaction injection molding process.

3. The mixing head of claim 1, wherein the high-viscosity starting material contains filler material.

4. The mixing head of claim 1, wherein the feed passageway, the return passageway, and the flow communication between the feed passageway and the return passageway are constructed in the absence of a substantial cross section narrowing.

5. The mixing head of claim 1, wherein the feed passageway, the return passageway, and the flow communication between the feed passageway and the return passageway have a same cross section.

6. The mixing head of claim 1, wherein the flow communication between the feed passageway and the mixing chamber has a substantial same flow cross section as the feed passageway.

7. The mixing head of claim 1, wherein the switchover device includes a cleaning piston disposed in the mixing chamber for back-and-forth movement, said cleaning piston being constructed to establish a flow communication between the feed passageway and the return passageway in a first position, and a flow communication between the feed passageway and the mixing chamber in a second position.

8. The mixing head of claim 7, wherein the second position of the cleaning piston is a retracted disposition of the cleaning piston in the mixing chamber.

9. The mixing head of claim 7, wherein the cleaning piston has one end constructed to deflect the high-viscosity starting material from the feed passageway into the mixing chamber.

10. The mixing head of claim 9, wherein the one end of the cleaning piston is configured in the form of a protruding nose.

11. The mixing head of claim 10, wherein the nose is sized to form a barrier against the return passageway, when the cleaning piston is in the second position.

12. The mixing head of claim 7, wherein the cleaning piston has a bore or annular groove to establish the flow communication between the feed passageway and the return passageway, when the cleaning piston assumes the first position.

13. The mixing head of claim 1, further comprising a plurality of said injection port.

14. The mixing head of claim 13, wherein the injection ports are disposed about the mixing chamber substantially in the form of a ring.

15. The mixing head of claim 1, further comprising an injection nozzle in alignment with the injection port for injecting the low-viscosity starting material into the mixing chamber.

16. The mixing head of claim 13, further comprising a plurality of injection nozzles disposed in alignment with the injection ports in one-to-one correspondence, wherein the injection nozzles are operated independently from one another.

17. The mixing head of claim 15, wherein the at least one member selected from the group consisting of injection port and injection nozzle is configured for injection of the low-viscosity starting material into the mixing chamber at high pressure.

18. A method of operating a mixing head constructed for mixing two starting materials, comprising the steps of:
connecting a feed passageway with a return passageway for circulation of a first starting material which contains fibers,
cutting a flow communication between the feed passageway and the return passageway, thereby opening a flow communication between the feed passageway and a mixing chamber for introduction of the first starting material into the mixing chamber;
injecting a second starting material of lower viscosity than the first starting material into the mixing chamber at a location downstream of the introduction of the first starting material into the mixing chamber, thereby mixing the first and second starting materials to produce a reactive mixture; and
discharging the reactive mixture from the mixing chamber.

19. The method of claim 18, wherein at least some of the fibers of the first starting material have a length of more than 0.5 mm.

20. The method of claim 18, wherein at least some of the fibers of the first starting material have a length of more than 1 mm.

21. The method of claim 18, wherein at least some of the fibers of the first starting material have a length of more than 3 mm.

22. The method of claim 18, wherein the introduction of the first starting material into the mixing chamber is implemented at low pressure.

23. The method of claim 18, wherein the injecting step is implemented at high pressure.

24. The method of claim 18, wherein the connecting step involves substantially same flow cross section of feed and return passageways.

25. The method of claim 18, wherein the connecting, cutting, injecting and discharging steps are cyclically repeated.
